(19) United States
(12) Patent Application Publication
(10) Pub. No.: US 2016/0286017 A1
(43) Pub. Date: Sep. 29, 2016

(54) Interactive Response Telephony

(71) Applicant: Microsoft Technology Licensing, LLC, Redmond, WA (US)

(72) Inventor: Mark Rubinstein, Seattle, WA (US)

(21) Appl. No.: 14/670,835

(22) Filed: Mar. 27, 2015

(51) Int. Cl. H04M 1/247; H04M 3/51

(52) U.S. Cl. CPC H04M 1/2477; H04M 3/5166

(57) ABSTRACT

Example telephones and methods decouple acquiring and presenting visual representations of menu systems associated with interactive voice response (IVR) systems from a user experience interaction with the IVR system. IVRs with which a user is likely to interact are identified and data about those IVRs is acquired at a time other than a user experience telephone call. The time when data is acquired may depend on a state of the telephone, user, or environment. When a call to the IVR is made, data about the IVR is already on the telephone, therefore communication with an omnibus database that stores information about many IVR systems is not required, which improves the efficiency of telephone calls made to IVRs. Menus can be displayed on and user inputs received from the telephone while or even before the outgoing call to the IVR is established, reducing the time required to interact with IVRs.

### BACKGROUND

There are many telephone numbers that when dialed present a caller with an interactive voice response (IVR) system. We are all familiar with spending annoyingly long amounts of time listening to and navigating through several layers of a voice menu system before ultimately entering our choice. While in theory a user may call any of the millions of numbers that are supported by IVR systems, in practice users tend to call just a small subset of these numbers over and over. For example, while a thousand different banks may have IVR systems, any single user is only likely to call one or two of these banks.

People have already addressed the problem of presenting a touch screen text or graphics based representation of an IVR menu system. People have also already addressed the problem of discovering which phone numbers have IVR systems and automatically populating a database that facilitates replacing the slow IVR experience with a faster graphical experience. However, conventional systems may actually slow down the IVR caller experience even more by intercepting phone calls and then making repeated interactions with a server based database that supports the graphical experience for all numbers that are known to be supported by an IVR system. The repeated communications that conventional systems make with a server-based database may also drain the battery of a handheld phone and impact the cost of using the phone by consuming data that is part of a data plan. Data plan concerns may be particularly poignant in emerging markets where access to computers may be limited, which may in turn increase the likelihood that a user may call an IVR. In emerging markets, low limit data plans may be in place, which may even further exacerbate data plan concerns.

Conventional systems intercept a call, query a server-based database, and if visual data for the IVR is available, provide the visual data to the phone. However, there are at least two problems with this approach. First, while the phone is interacting with the database, the user is waiting an extra period of time and using additional battery, bandwidth, and data. Second there is no guarantee that the database has an up-to-date version of the IVR menu system. Therefore, the resources consumed may be wasted on acquiring out-of-date information that may actually hinder the phone call experience rather than enhance it.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter. Example apparatus and methods mitigate or eliminate the delay associated with server-based database support of textual representations for an IVR system and also mitigate or eliminate issues associated with the database having out-of-date menu information.

Example apparatus may include a telephone whose memory stores data associated with an interactive response telephony system (IRTS), an interactive voice response (IVR) system, or, more generally, an interactive response system (IRS). The telephone selectively populates its memory with visual representations or outbound signals associated with various IRS. IRS with which a user is most likely to interact may be preferred. The visual representations and outbound signals may be acquired while there is no user experience based outgoing phone call in progress. This decouples data acquisition from the user experience, which improves the IRS experience from the point of view of the user, and which may also increase the efficiency of an IRS experience. The telephone detects an outgoing phone call directed to the IRS and presents a menu item from data already stored on the telephone. The telephone detects an input responsive to the menu item and selectively provides an outbound signal to the IRS. The outbound signal may be produced from data already stored on the telephone. The outbound signal may be a series of dual tone multi-frequency (DTFM) touch tones, a series of two or more audible menu entry identifiers, a series of two or more inaudible menu entry identifiers, or other signals. The telephone may present the menu item while or even before the outgoing phone call is established. Similarly, the telephone may prepare the outbound signal(s) while or even before the outgoing phone call is established. The data about the IRS may be acquired using a pull model or an asynchronous push model. The data about the IRS may be opportunistically acquired when resource availability for the telephone falls within a desired threshold. Criteria about which data to acquire or when to acquire that data may be updated opportunistically based on a phone attribute, an environmental attribute, or a user attribute.

Example methods may be performed by a telephone and may include acquiring data about an IRS with which a user of the telephone is likely to interact. Unlike conventional systems, the data is acquired while no user experience telephone call is being processed by the telephone and is not acquired in response to a user experience telephone call being made. A user experience telephone call is one made by the user to an IRS in which the user will experience the interactive response system. The data is stored on the telephone and thus is already accessible when an outgoing call is made. Example methods may include determining that an outgoing call is to be established by the telephone and using data already on the telephone to display a visual representation (e.g., menu item) associated with the IRS and to prepare a signal to provide to the IRS. Displaying menu items and generating outbound signals can proceed independent (e.g., asynchronously) of the establishment or progress of the phone call. Data stored on the telephone may be opportunistically updated based on a state of the user of the telephone, a state of a data communication environment in which the telephone is located, or a state of the telephone.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates a conventional system where a telephone interacts with an external database during a telephone call to an interactive voice response (IVR) system.

FIG. 2 illustrates an example system where a telephone does not interact with an external database during a telephone call to an IVR system.

FIG. 3 illustrates a method associated with improved interactive response telephony.

FIG. 4 illustrates a method associated with improved interactive response telephony.

FIG. 5 illustrates an apparatus associated with improved interactive response telephony.

FIG. 6 illustrates an apparatus associated with improved interactive response telephony.

FIG. 7 illustrates an example cloud operating environment in which an example system or method may operate.

FIG. 8 is a system diagram depicting an exemplary mobile communication device that may support improved interactive response telephony.

### DETAILED DESCRIPTION

Example apparatus and methods decouple acquiring and presenting visual representations of menu systems associated with interactive response systems (IRS), (e.g., interactive voice response (IVR) systems) from a user-experience based telephone call to the IRS. Conventional systems tightly couple acquiring and presenting visual representations to an outgoing user experience telephone call. A user experience telephone call is one made by the user to an IRS in which the user will experience the interactive response system. An IRS that a user is likely to interact with is identified and data about that IRS is acquired at a time other than when the user calls the IRS. The time when data is acquired may depend on a state of the telephone, user, or environment. For example, having a cheap, fast, and secure non-cellular connection available may prompt the telephone to acquire information about IRS with which the user is likely to interact. In another example, the telephone may be more likely to acquire information about IRS with which the user is likely to interact when a non-metered data connection is available. Later, when a call to the IRS is made, data about the IRS is already on the telephone. Therefore, communication with an omnibus database that stores information about many IRS systems is not required as in conventional systems. Not having to delay a phone call while connecting to and acquiring data from an external database improves the efficiency of telephone calls made to IRS. In one embodiment, menus can be displayed and user inputs can be received from the phone while or even before the outgoing call to the IRS is established. This also improves efficiency by reducing the time required to interact with IRS.

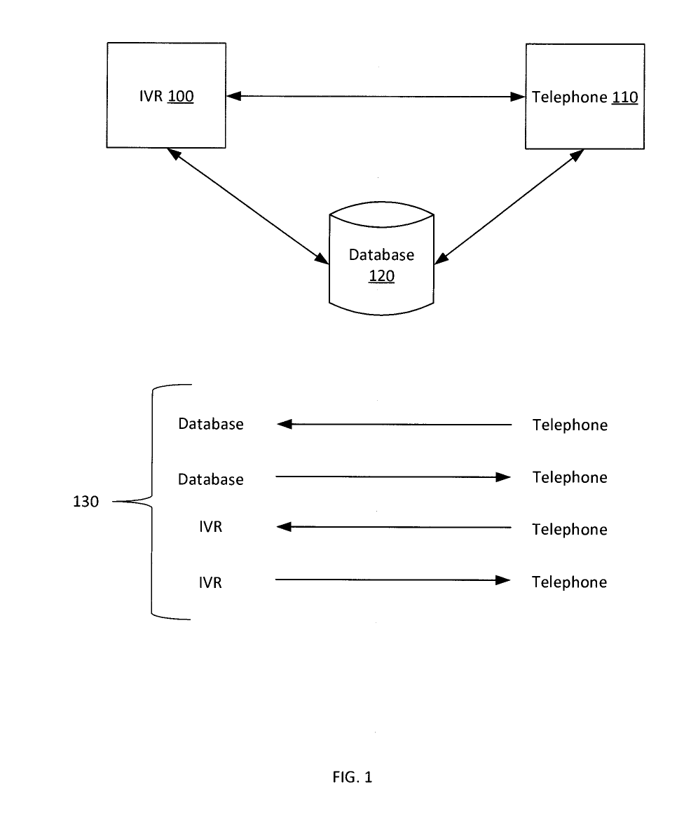

FIG. 1 illustrates a conventional system where a telephone 110 interacts with an external database 120 during a telephone call to an interactive voice response (IVR) system 100. The series 130 of communications illustrates that the telephone 110 communicates with the database 120 before the telephone 110 communicates with the IVR 100. Communicating with the database 120 before communicating with the IVR 110 makes the phone call longer than necessary, consumes more resources than are required, and blocks opportunities for parallel processing. This concrete, real-world problem only came into existence recently as phones gained the ability to display graphical information, to interact with interactive voice response systems, and to interact with external database systems.

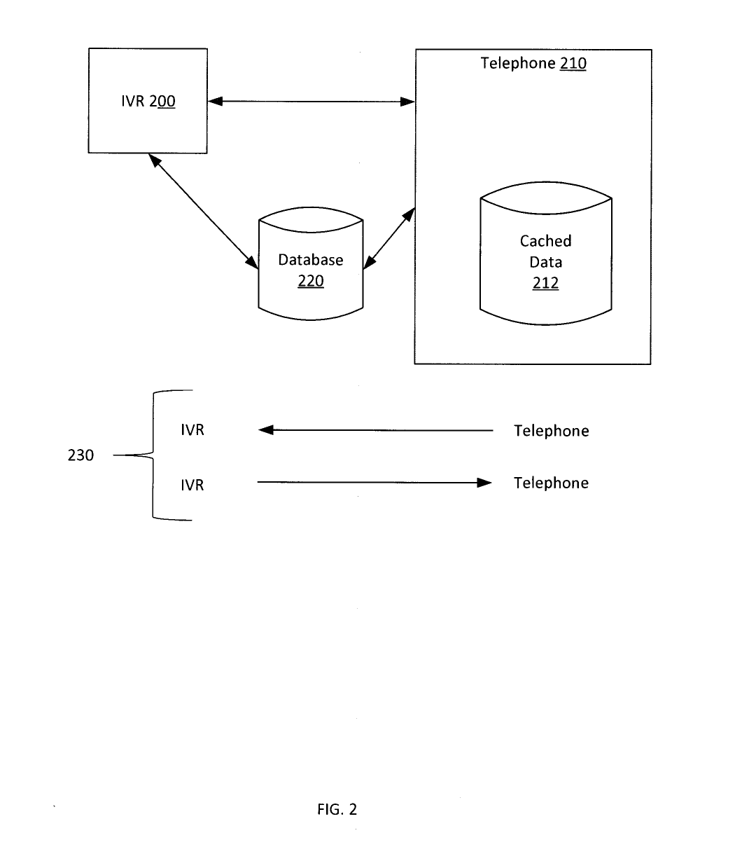

FIG. 2 illustrates an example system where a telephone 210 does not interact with an external database 220 during a telephone call to an IVR system 200. The series 230 of communications illustrates that the telephone 210 communicates with the IVR system 200 first. While the telephone 210 may selectively communicate with a database 220 after communicating with the IVR system 200, this communication is elective and does not occur before or during the communication with the IVR system 200. Thus, the approach illustrated in FIG. 2 is more efficient than conventional systems. No time or computing resources are wasted communicating with the database 220 when an outgoing call is made from the telephone 210 to the IVR system 200. Instead, data is opportunistically acquired and stored in cached data 212 when the telephone 210 is not making a call to the IVR system 200. The cached data 212 allows the telephone 210 to display menus and acquire user responses while or even before the phone call from telephone 210 to IVR system 200 is established.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, distributions, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, system-on-a-chip (SoC), or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

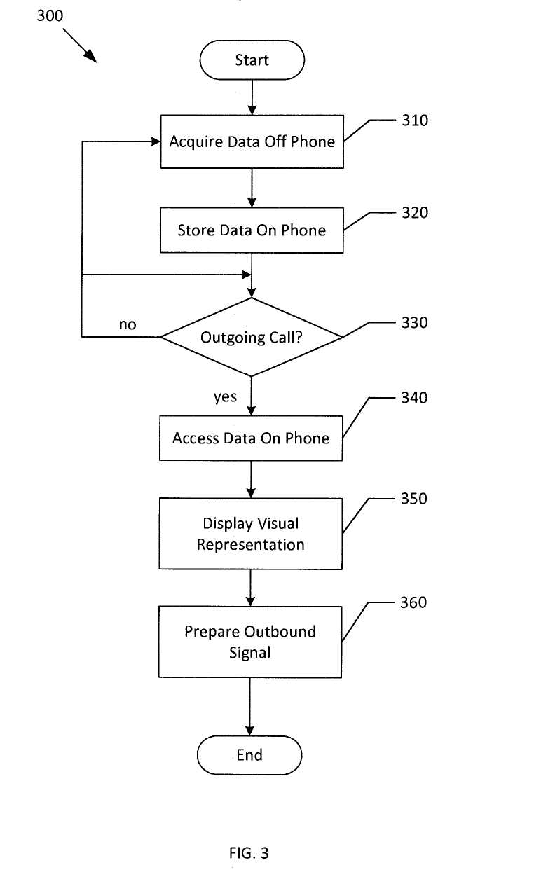

FIG. 3 illustrates a computerized method 300 that may be performed by a telephone. A “telephone” refers to, for example, a cellular telephone, a satellite telephone, a smartphone, or other device that includes circuitry or other apparatus for making a telephone call.

Method 300 includes, at 310, acquiring first data about one or more interactive response systems with which a user of the telephone is likely to interact. The first data may be acquired from various sources off the telephone. Unlike conventional systems, the first data is not acquired in response to a user experience telephone call being made to an IVR system. Thus, the data may be acquired while no user experience telephone call is being processed by telephone. In one embodiment, the data may be acquired while an unrelated telephone call is being processed. The difference between this approach and the conventional approach is that the conventional approach intercepts a user experience telephone call and then accesses an external database to acquire information (e.g., menu items) to display. Method 300 does not delay the outgoing call by accessing the external database. Instead, data associated with interactive response systems with which the user is likely to interact is pre-acquired at 310 and stored on the telephone at 320.

Method 300 proceeds, at 330, to make a determination of whether an outgoing call is to be established by the telephone. If the determination is yes, then processing may continue at 340. If the determination is no, then processing may return to 310 where additional data may be acquired or where already acquired data may be verified. In one embodiment, method 300 may simply wait at 330 until an outgoing phone call is detected.

Upon determining that an outgoing user experience call is to be established by the telephone, method 300 proceeds, at 340, by accessing second data that is already stored on the telephone. The second data is a subset of the first data and concerns a specific interactive response system associated with the destination of the outgoing call. Like conventional systems, the second data may be stored in a database or other data structure that can be searched or indexed. Unlike conventional systems, the second data is already on the telephone and no external communication is required when the phone call is made to acquire or access the call-specific data.

Method 300 then proceeds, at 350, by selectively displaying on the telephone a visual representation associated with the interactive response system. Unlike conventional systems that display a menu item acquired from an external database during the phone call, method 300 displays a visual representation that is produced based, at least in part, on data that was already on the phone.

Method 300 then proceeds, at 360, to prepare a signal to provide to the interactive response system. The signal is prepared in response to detecting a user response associated with the visual representation. Once again, the signal is produced based, at least in part, on data that was already in the telephone.

Displaying a menu item from data that was already in the telephone and preparing an outbound signal from data that was already in the telephone makes the telephone operate more efficiently by removing the need to acquire external data. The improved efficiency may reduce resources (e.g., bandwidth, processor cycles, battery power) involved in interacting with an interactive response system.

Decoupling acquiring the data to display and the signals to provide from the user experience phone call facilitates improving efficiency even further by allowing parallel processing. For example, a user of the phone may navigate the menu system and queue up signals to provide while or even before the outgoing call is established. Thus, in one example, selectively displaying the visual representation proceeds independent of the progress of the outgoing call. Similarly, in one example, selectively preparing the signal proceeds independent of the progress of the outgoing call. Proceeding independent of the progress of the outgoing phone call means that the menu items can be displayed and user responses acquired regardless of the progress of the telephony circuitry, apparatus or software in dialing the phone number and establishing a circuit, virtual circuit, or other connection with the target phone number.

Consider a cellular telephone call. A user may select the number and press send. The telephone needs to locate and communicate with a cellular telephone tower or apparatus and send the telephone number and other information. The telephone infrastructure then finds the target number and sends electrical signals that cause the target phone to ring. The target phone may then send electrical signals that indicate that the call has been answered. The target phone may then send information (e.g., an automated reply). While all this is happening, the user can be interacting with the menu system that is already stored in their phone. When the call is finally established, the tone, tones, series of tones, or other menu indicators may be provided to the target phone. There's no need to wait for the call to be established before presenting the user with the menu system. Thus, unlike conventional systems that may access a database to acquire menu information and that may also wait for the call to be established, example apparatus and methods may proceed in parallel to improve telephone efficiency.

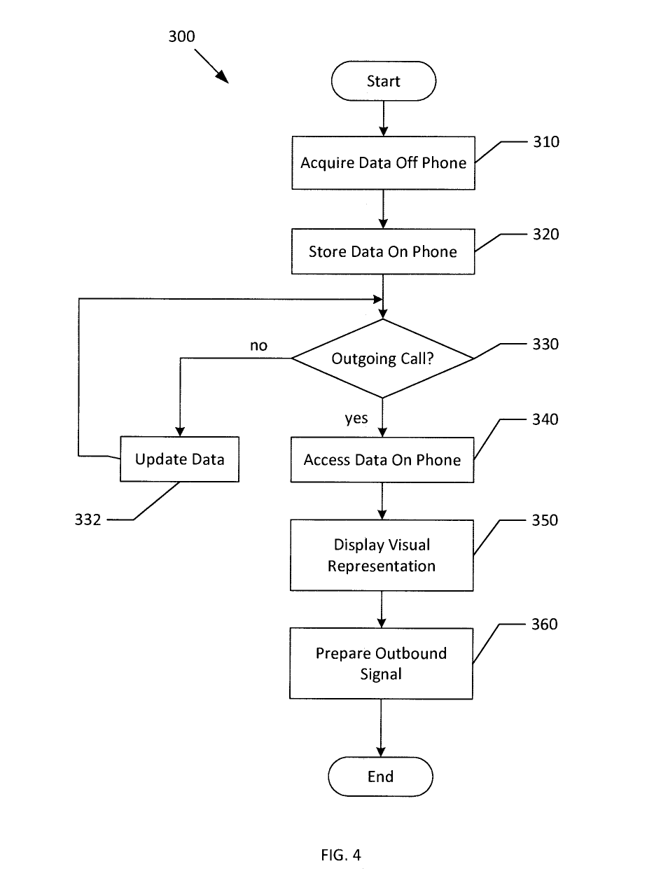

FIG. 4 illustrates another embodiment of method 300. This embodiment also includes, at 332, opportunistically updating the data stored on the telephone. The data is updated opportunistically, meaning that the data may be updated at a convenient or appropriate time that is determined based on a state of the user of the telephone, a state of a data communication environment in which the telephone is located, or a state of the telephone. The state of the user may include, for example, information about interactive response systems with which the user has interacted. The state of the user may include, for example, how many times a user has interacted with an interactive response system, from where the user typically calls the interactive response system, what the user does before calling the interactive response system, how recently the user has called the interactive response system, and other information. This information may allow the telephone to decide for which, if any, interactive response systems to store menu items and outbound signals. Conventional systems are built on the assumption that information about every known interactive voice response system needs to be stored on a database. The comprehensive conventional approach introduces inefficiencies into each phone call. Example systems and methods rely on the fact that users tend to interact with a relatively small set of known interactive voice response systems. Rather than deal with the general case, example systems and methods provide a more efficient approach to dealing with relevant interactive voice response systems.

The state of the data communication environment may include, for example, a speed, cost, security, or availability of a non-cellular internet connection available to the telephone. For example, when a user is in a coffee shop that has free WiFi available, then the phone may decide to update the data it has stored for interactive systems with which the user tends to interact. The state of the data communication environment may also include, for example, activity to particular ISRs. For example, if there is more than a threshold amount of activity to a particular ISR, then the phone may decide to acquire or update information for that ISR even if the user of the phone has not yet called that ISR.

The state of the telephone may include, for example, a processor load, an amount of memory available to the telephone, or an amount of battery power available to the telephone. For example, if the processor on the phone is operating below a threshold amount, if there is some unused memory, and if there is battery power available, then the phone may decide to go ahead and acquire data or update data about the interactive systems with which the user tends to interact. The number of interactive systems for which data is acquired may depend on the user, data communication, or telephone attributes. For example, when the phone is in a free WiFi environment, has lots of processor cycles and memory available, is plugged in, and the user has been interacting with a certain set of interactive systems, the phone may decide to update all the systems with which the user has interacted and some additional systems that are related to the systems with which the user has interacted. But if the phone is in a higher cost communication environment, has limited processor cycles or memory, and the user has only been calling one interactive system, then the phone may elect to update data associated with just that one system or may decide not to update at all.

While FIGS. 3 and 4 illustrate various actions occurring in serial, it is to be appreciated that various actions illustrated in FIGS. 3 and 4 could occur substantially in parallel. By way of illustration, a first process could acquire and store data, a second process could handle outgoing phone calls, and a third process could control when data is acquired and stored. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage device may store computer executable instructions that if executed by a machine (e.g., computer) cause the machine to perform methods described or claimed herein including method 300. While executable instructions associated with the above methods are described as being stored on a computer-readable storage device, it is to be appreciated that executable instructions associated with other example methods described or claimed herein may also be stored on a computer-readable storage device. In different embodiments the example methods described herein may be triggered in different ways. In one embodiment, a method may be triggered manually by a user. In another example, a method may be triggered automatically.

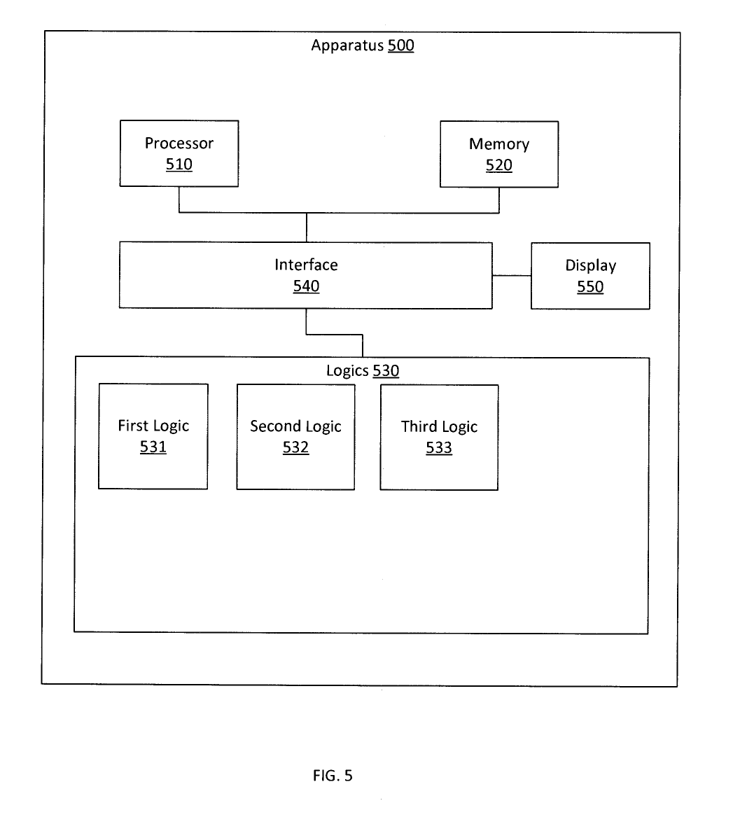

FIG. 5 illustrates an apparatus 500 (e.g., telephone) that improves interactions with automated response systems (e.g., interactive voice response systems). Apparatus 500 may include a processor 510, a memory 520, a set 530 of logics, a display 550, and an interface 540 that connects the processor 510, the memory 520, the display 550, and the set 530 of logics. The processor 510 may be, for example, a microprocessor in a computer, a specially designed circuit, a field-programmable gate array (FPGA), an application specific integrated circuit (ASIC), a processor in a mobile device, a system-on-a-chip, a dual or quad processor, or other computer hardware. The memory 520 may store data associated with an interactive response system. For example, memory 520 may store text or graphics associated with displaying a menu. Memory 520 may also store response codes (e.g., touch tone codes, deep codes, identifiers) that can be provided in response to inputs made on the menu.

Apparatus 500 may interact with other apparatus, processes, and services through, for example, a telephony system, a computer network, a data communications network, or voice communication network. Apparatus 500 may be, for example, a computer, a laptop computer, a tablet computer, a personal electronic device, a smart phone, a system-on-a-chip (SoC), or other device configured with a telephone circuit that can access and process data and that interacts with an IRS.

In one embodiment, the functionality associated with the set of logics 530 may be performed, at least in part, by hardware logic components including, but not limited to, field-programmable gate arrays (FPGAs), application specific integrated circuits (ASICs), application specific standard products (ASSPs), system on a chip systems (SOCs), or complex programmable logic devices (CPLDs).

The set 530 of logics may facilitate improving interactions with an IRS (e.g., interactive response telephony system) by managing visual representations and outbound signals for interacting with the interactive response system. The set 530 of logics may include a first logic 531 that selectively populates the memory 520 with visual representations or outbound signals associated with the interactive response telephony system. The first logic 531 may populate the memory 520 while there is no outgoing phone call in progress. More generally, the first logic 531 may populate the memory 520 at a time other than when the apparatus 500 is interacting with an IRS.

In one embodiment, the first logic 531 selectively populates the memory 520 by initiating contact with an external source of data independent of an outgoing phone call for which a menu item will be displayed. The first logic 531 may, additionally or alternatively, populate the memory 520 in response to receiving data from an external source independent of an outgoing phone call for which a menu item will be displayed. Thus, first logic 531 may participate in a pull model where apparatus 500 initiates acquiring data or first logic 531 may participate in a push model where apparatus 500 does not initiate the data acquisition.

In one embodiment, the first logic 531 selectively populates the memory 520 in response to determining that resource availability for the telephone falls within a desired threshold. The desired threshold may be based, at least in part, on a type of non-cellular connection to the internet available to the telephone 500, a cost of a non-cellular connection to the internet available to the telephone 500, a speed of a non-cellular connection to the internet available to the telephone 500, a security of a non-cellular connection to the internet available to the telephone 500, a load being experienced by the processor 510, a capacity available to the memory 520, or other information concerning apparatus 500.

The set 530 of logics may also include a second logic 532 that selectively controls the display 550 to present a menu item stored in the memory 520. The menu item may be displayed in response to detecting an outgoing phone call directed to the interactive response telephony system. Unlike conventional systems that acquire data from an omnibus, general purpose repository when a call is made, second logic 532 uses data that is already stored in memory 520. Since second logic 532 does not have to interact with an external database, and does not even actually need to interact with the IRS to begin displaying the menu items, in one embodiment, the second logic 532 controls the display 550 to present the menu item before the outgoing phone call is established or while the outgoing phone call is being established.

The set 530 of logics may also include a third logic 533 that selectively provides to the interactive response system an outbound signal from the memory 520 or from data stored in the memory 520. Third logic 533 may provide the outbound signal in response to detecting an input responsive to the menu item selected by second logic 532. Once again, since the third logic 533 does not have to interact with an external database or data repository on each outgoing phone call, in one embodiment, the third logic 533 can prepare the outbound signal before the outgoing phone call is established or while the outgoing phone call is being established. The second logic 532 can display menu items and the third logic 533 can prepare outbound signals while the outgoing phone call is being set up.

Interactive response systems may change their menu items or response codes. Thus, in one embodiment, the second logic 532 verifies with the IRS that the menu item is up-to-date before controlling the display 550 to present the menu item. Similarly, in one embodiment, the third logic 533 verifies with the IRS that the outbound signal is up-to-date before providing the outbound signal.

The outbound signal may be, for example, a dual tone multi-frequency (DTFM) touch tone, an audible menu entry identifier, or an inaudible menu entry identifier. In one embodiment, multiple signals may be prepared. Thus, the outbound signal may be a series of two or more DTFM touch tones, a series of two or more audible menu entry identifiers, or a series of two or more inaudible menu entry identifiers.

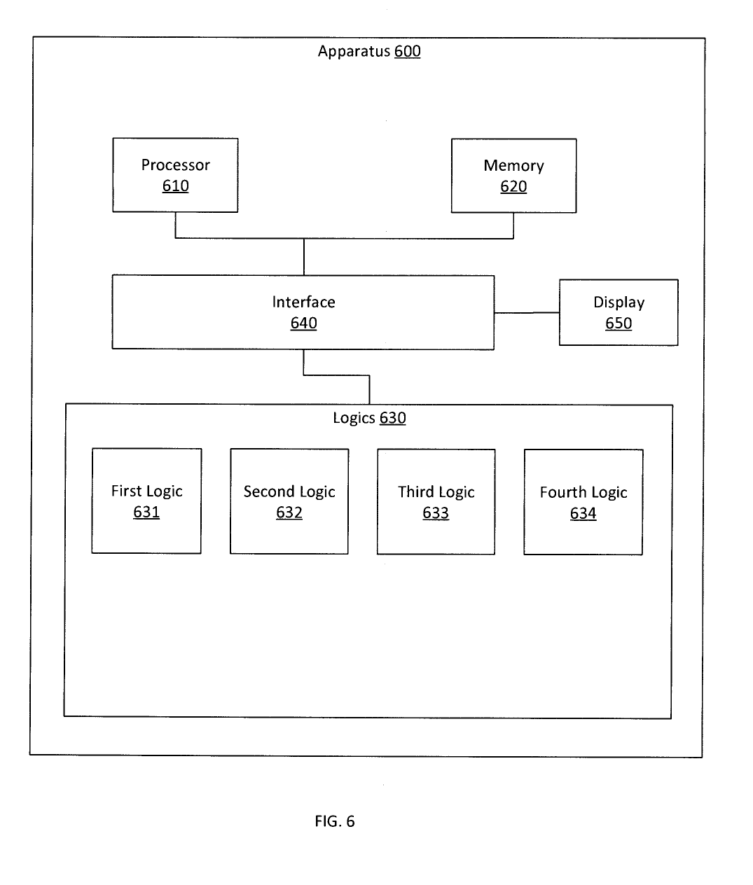

FIG. 6 illustrates an apparatus 600 that is similar to apparatus 500 (FIG. 5). For example, apparatus 600 includes a processor 610, a memory 620, a set of logics 630 that correspond to the set of logics 530 (FIG. 5), a display 650, and an interface 640. However, apparatus 600 includes a fourth logic 634 that selectively updates decision criteria upon which the first logic 631, the second logic 632, or the third logic 633 may make decisions. The decision criteria may control for which interactive IRS data will be stored in the memory 620 or may control which data associated with an IRS will be updated.

The fourth logic 634 may update the decision criteria, based, at least in part, on a phone attribute, an environmental attribute, or a user attribute. For example, the fourth logic 634 may selectively update first decision criteria considered by the first logic 631 to decide how or when to populate the memory 620. The fourth logic 634 may selectively update second decision criteria considered by the second logic 632 to decide how or when to control the display 650 to present the menu item. The fourth logic 634 may also selectively update third decision criteria considered by the third logic 633 to decide how or when to provide the outbound signal.

The phone attribute may be, for example, the amount of free space in the memory 620, the speed of the processor 610, a load being experienced by the processor 610, an amount of battery life available to the telephone 600, or other phone-related data. The environmental attribute may be, for example, a bandwidth of a communication channel available to the telephone 600, a cost associated with the communication channel available to the telephone 600, a security of a communication channel available to the telephone 600, a speed of the communication channel available to the telephone 600, the availability of a non-metered data connection to the telephone 600, or other environmental information. The user attribute may be, for example, an identity of an interactive response system that the phone 600 has interacted with beyond a threshold period of time or an identity of an interactive response system that the phone 600 has interacted with inside a threshold period of time. The user attribute may also be, for example, an identity of a website that the phone 600 has interacted with beyond a threshold period of time, an identity of a website that the phone 600 has interacted with inside a threshold period of time, an identity of a website that the phone 600 is currently interacting with, where the phone 600 is currently located, or other information about the user of the phone 600.

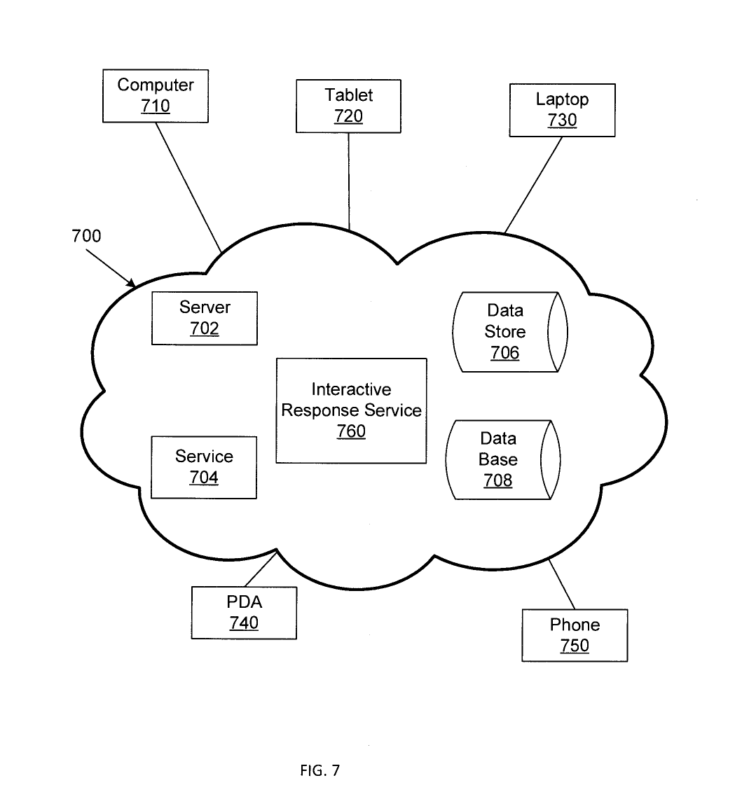

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example interactive response service 760 residing in the cloud. The interactive response service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the interactive response service 760.

FIG. 7 illustrates various devices accessing the interactive response service 760 in the cloud. The devices include a computer 710, a tablet 720, a laptop computer 730, a personal digital assistant 740, and a mobile device (e.g., cellular phone, satellite phone, wearable computing device) 750. The interactive response service 760 may provide data for improving interactive response telephony. For example, interactive response service 760 may identify an IRS with which phone 750 is likely to interact and push data to phone 750.

It is possible that different users at different locations using different devices may access the interactive response service 760 through different networks or interfaces. In one example, the interactive response service 760 may be accessed by a mobile device 750. In another example, portions of interactive response service 760 may reside on a mobile device 750.

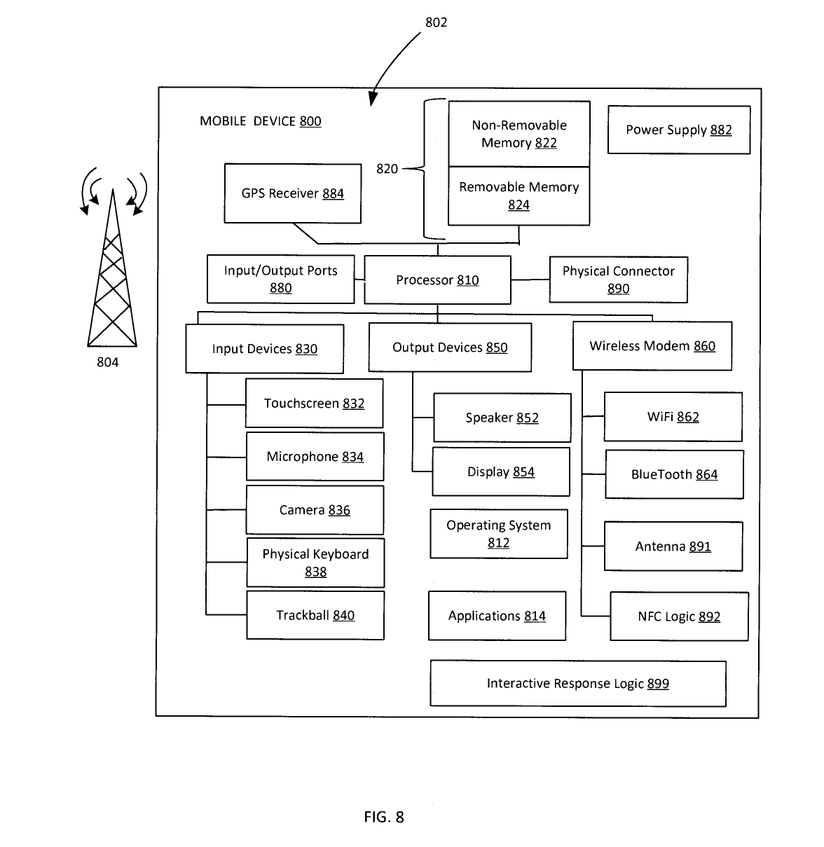

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 may be a variety of computing devices (e.g., cell phone, smartphone, handheld computer, Personal Digital Assistant (PDA), wearable computing device, etc.) and may allow wireless two-way communications with one or more mobile communications networks 804, such as a cellular or satellite network.

Mobile device 800 can include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814.

Mobile device 800 can include memory 820. Memory 820 can include non-removable memory 822 or removable memory 824. The non-removable memory 822 can include random access memory (RAM), read only memory (ROM), flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include visual representations (e.g., menu items), response codes (e.g., DTFM tones), or other data. The memory 820 can be used to store a subscriber identifier, such as an International Mobile Subscriber Identity (IMSI), and an equipment identifier, such as an International Mobile Equipment Identifier (IMEI). The identifiers can be transmitted to a network server to identify users or equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition (both on screen and adjacent to the screen), air gestures, head and eye tracking, voice and speech, vision, touch, gestures, and machine intelligence. Other examples of a NUI include motion gesture detection using accelerometers/gyroscopes, facial recognition, three dimensional (3D) displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can include speech-recognition software as part of a voice user interface that allows a user to operate the device 800 via voice commands. Further, the device 800 can include input devices and software that allow for user interaction via a user's spatial gestures, such as detecting and interpreting gestures to provide input to an interactive response system.

A wireless modem 860 can be coupled to an antenna 891. In some examples, radio frequency (RF) filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a Global system for mobile communications (GSM) network for data and voice communications within a single cellular network, between cellular networks, or between the mobile device and a public switched telephone network (PSTN). NFC logic 892 facilitates having near field communications (NFC).

The mobile device 800 may include at least one input/output port 880, a power supply 882, a satellite navigation system receiver 884, such as a Global Positioning System (GPS) receiver, or a physical connector 890, which can be a Universal Serial Bus (USB) port, IEEE 1394 (FireWire) port, RS-232 port, or other port. The illustrated components 802 are not required or all-inclusive, as other components can be deleted or added.

Mobile device 800 may include interactive response logic 899 that is configured to provide a functionality for the mobile device 800. For example, interactive response logic 899 may provide a client for interacting with a service (e.g., service 760, FIG. 7). Portions of the example methods described herein may be performed by interactive response logic 899. Similarly, interactive response logic 899 may implement portions of apparatus described herein. Interactive response logic 899 may opportunistically acquire data associated with an IRS and then use that pre-acquired data to improve both a user experience and the efficiency of an interaction with an IRS.

### Aspects of Certain Embodiments

In one embodiment, a phone includes a processor, a memory, and a set of circuits or logics. The phone may include a physical interface to connect the processor, the memory, and the set of logics. The memory stores electronic data associated with improving interactive response telephony. The phone may facilitate improving interactions with an IRS (e.g., interactive response telephony system) by managing visual representations and outbound signals for interacting with the IRS. The phone may selectively populate its memory with visual representations (e.g., menu items) or outbound signals (e.g., DTFM tones) associated with the IRS. The phone may populate the memory when there is no outgoing user experience phone call in progress. More generally, the phone may populate the memory at a time other than when the phone is interacting with an IRS.

The phone may selectively populate its memory by initiating contact with an external source of data independent of an outgoing user experience phone call for which a menu item will be displayed. The phone may, additionally or alternatively, populate its memory in response to receiving data from an external source independent of an outgoing phone call for which a menu item will be displayed. The phone may opportunistically populate its memory in response to determining that resource availability falls within a desired threshold. The desired threshold may be based, at least in part, on a type of non-cellular connection to the internet available to the telephone, a cost of a non-cellular connection to the internet available to the telephone, a speed of a non-cellular connection to the internet available to the telephone, a security of a non-cellular connection to the internet available to the telephone, a load being experienced by the processor on the telephone, a capacity available to the memory on the telephone, the availability of sufficient power or connection to a power source, or other information concerning the telephone.

The phone may selectively control the display to present a menu item stored in the phone's memory. The menu item may be displayed in response to detecting an outgoing phone call directed to the IRS. Unlike conventional systems that acquire data from an omnibus, general purpose repository when a call is made, the phone uses data that is already stored in its memory. Since the phone does not have to interact with an external database, and does not even actually need to interact with the IRS to begin displaying the menu items, the phone may control the display to present the menu item before the outgoing phone call is established or while the outgoing phone call is being established.

The phone may selectively provide to the IRS an outbound signal from the phone's memory or from data stored in the phone's memory. The phone may provide the outbound signal in response to detecting an input responsive to the displayed menu item. Once again, since the phone does not have to interact with an external database or data repository on each outgoing phone call, in one embodiment, the phone can even prepare the outbound signal before the outgoing phone call is established or while the outgoing phone call is being established. The phone can display menu items and can prepare outbound signals asynchronously from the progress of the actual phone call to the ISR.

An example phone produces a technical effect of reducing the duration of a call that interacts with an IVR system. The reduction is achieved by eliminating the per-call interaction with an omnibus database that provides IVR menu information. The per-call interaction is eliminated by intelligent, opportunistic acquisition of selected IVR information.

In one embodiment, a method performed on a telephone includes identifying an interactive response system (IRS) for which a likelihood that a user of the telephone will interact with the interactive response system exceeds a threshold. Once the IRS has been identified, the method includes acquiring data about the IRS at a time other than when the user is engaged in a user experience phone call with the IRS. The data includes information from which a visual display of the IRS can be produced. The data is acquired opportunistically at a time determined, at least in part, on a state of the telephone. The method includes, upon determining that an outgoing communication associated with a particular IRS is to be established by the telephone, accessing data stored on the telephone concerning the particular IRS. The method includes selectively displaying on the telephone a visual representation (e.g., menu item) associated with the particular IRS. The visual representation is produced based, at least in part, on data stored on the telephone and associated with the particular IRS. The visual representation is prepared and displayed asynchronously with the progress of the outgoing communication. The method includes, upon detecting a user response associated with the visual representation, selectively preparing a signal to provide to the particular IRS. The signal is produced based, at least in part, on data stored on the telephone and associated with the particular IRS. The signal is produced asynchronously with the progress of the outgoing communication.

The method solves the problem of delaying every phone call targeted to an IVR until a communication with an omnibus external IVR database can be consulted. The method produces the technical effect of reducing data communications, power consumption, and processor cycles consumed during an interaction with an IVR.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage device”, as used herein, refers to a device that stores instructions or data. “Computer-readable storage device” does not refer to propagated signals. A computer-readable storage device may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage devices may include, but are not limited to, a floppy disk, a flexible disk, a hard disk, a magnetic tape, other magnetic medium, an application specific integrated circuit (ASIC), a compact disk (CD), a random access memory (RAM), a read only memory (ROM), a memory chip or card, a memory stick, and other media from which a computer, a processor or other electronic device can read.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A telephone, comprising:
a processor;
a display;
a memory that stores data associated with an interactive response telephony system;
a set of logics that manage visual representations or outbound signals for interacting with the interactive response telephony system; and
a hardware interface to connect the processor, the display, the memory, and the set of logics;
the set of logics comprising:
a first logic that, while there is no outgoing use experience phone call in progress, selectively populates the memory with visual representations or outbound signals associated with the interactive response telephony system;
a second logic that in response to detecting an outgoing user experience phone call directed to the interactive response telephony system selectively controls the display to present a menu item stored in the memory; and
a third logic that in response to detecting an input responsive to the menu item selectively provides an outbound signal from the memory to the interactive response telephony system.

2. The telephone of claim 1, where the outbound signal is a dual tone multi-frequency (DTFM) touch tone, an audible menu entry identifier, or an inaudible menu entry identifier.

3. The telephone of claim 1, where the outbound signal is a series of two or more dual tone multi-frequency (DTFM) touch tones, a series of two or more audible menu entry identifiers, or a series of two or more inaudible menu entry identifiers.

4. The telephone of claim 1, where the second logic controls the display to present the menu item before the outgoing phone call is established or while the outgoing phone call is being established.

5. The telephone of claim 1, where the third logic prepares the outbound signal before the outgoing phone call is established or while the outgoing phone call is being established.

6. The telephone of claim 1, where the second logic verifies with the interactive response telephony system that the menu item is up-to-date before controlling the display to present the menu item and where the third logic verifies with the interactive response telephony system that the outbound signal is up-to-date before providing the outbound signal.

7. The telephone of claim 1, where the first logic selectively populates the memory by initiating contact with an external source of data independent of an outgoing phone call for which a menu item will be displayed or in response to receiving data from an external source independent of an outgoing phone call for which a menu item will be displayed.

8. The telephone of claim 1, where the first logic selectively populates the memory in response to determining that resource availability for the telephone falls within a desired threshold.

9. The telephone of claim 8, where the desired threshold is based, at least in part, on a type of non-cellular connection to the Internet available to the telephone, a type of non-metered connection available to the telephone, a cost of a non-cellular connection to the internet available to the telephone, a speed of a non-cellular connection to the internet available to the telephone, a security of a non-cellular connection to the internet available to the telephone, a load being experienced by the processor, and a capacity available to the memory.

10. The telephone of claim 1, comprising a fourth logic that, based, at least in part, on a phone attribute, an environmental attribute, or a user attribute, selectively updates first decision criteria considered by the first logic to decide how or when to populate the memory, selectively updates second decision criteria considered by the second logic to decide how or when to control the display to present the menu item, or selectively updates third decision criteria considered by the third logic to decide how or when to provide the outbound signal.

11. The telephone of claim 10, where the first decision criteria, the second decision criteria, and the third decision criteria control for which interactive response telephony systems data will be stored in the memory or control which data associated with an interactive response telephony system will be updated.

12. The telephone of claim 11, where the phone attribute is the amount of free space in the memory, the speed of the processor, a load being experienced by the processor, an amount of power available to the telephone through a plugged-in electrical connection, or an amount of battery life available to the telephone.

13. The telephone of claim 11, where the environmental attribute is a bandwidth of a communication channel available to the telephone, a cost associated with the communication channel available to the telephone, a security of a communication channel available to the telephone, an availability of a non-metered connection, an amount of activity of other users with respect to an interactive response telephony system, or a speed of the communication channel available to the telephone.

14. The telephone of claim 11, where the user attribute is an identity of an interactive response telephony system interacted with by the telephone beyond a threshold period of time, an identity of an interactive response telephony system interacted with by the telephone inside a threshold period of time, an identity of a website interacted with by the telephone beyond a threshold period of time, an identity of a website interacted with by the telephone inside a threshold period of time, an identity of a website currently being interacted with by the telephone, or a user location.

15. A computerized method performed by a telephone, the method comprising:
acquiring first data about one or more interactive response systems with which a user of the telephone is likely to interact, where the first data is acquired while no user experience telephone call is being processed by telephone;
storing the first data on the telephone;
upon determining that an outgoing user experience call is to be established by the telephone:
accessing second data stored on the telephone concerning an interactive response system associated with the destination of the outgoing user experience call, where the second data is a subset of the first data;
selectively displaying on the telephone a visual representation associated with the interactive response system, where the visual representation is produced based, at least in part, on the second data; and
upon detecting a user response associated with the visual representation, selectively preparing a signal to provide to the interactive response system, where the signal is produced based, at least in part, on the second data.

16. The method of claim 15, where selectively displaying the visual representation proceeds independent of the progress of the outgoing user experience call.

17. The method of claim 16, where selectively preparing the signal proceeds independent of the progress of the outgoing user experience call.

18. The method of claim 17, comprising opportunistically updating the first data based on a state of the user of the telephone, a state of a data communication environment in which the telephone is located, or a state of the telephone.

19. The method of claim 18, where the state of the user includes identities of interactive response systems with which the user has interacted, where the state of the data communication environment includes activity of other users with respect to a particular ISR, a speed, cost, security, availability of a non-metered connection for the telephone, or availability of a non-cellular internet connection for the telephone, and where the state of the telephone includes a processor load, an amount of memory available to the telephone, an amount of plugged in power available to the telephone, or an amount of battery power available to the telephone.

20. A computer-readable storage device storing computer-executable instructions that when executed by a computer in a telephone control the telephone to perform a method, the method comprising:
identifying an interactive response system for which a likelihood that a user of the telephone will interact with the interactive response system exceeds a threshold;
acquiring data about the interactive response system, where the data includes information from which a visual display can be produced, and where the data is opportunistically acquired while the telephone is not engaged in a user experience data communication with the interactive response system and at a time determined, at least in part, on a state of the telephone;
storing the data on the telephone;
upon determining that an outgoing user experience communication associated with a particular interactive response system is to be established by the telephone:
accessing data concerning the particular interactive response system;
selectively displaying on the telephone a visual representation associated with the particular interactive response system, where the visual representation is produced based, at least in part, on the data associated with the particular interactive response system, and where the visual representation is displayed asynchronously with the progress of the outgoing communication; and
upon detecting a user response associated with the visual representation, selectively preparing a signal to provide to the particular interactive response system, where the signal is produced based, at least in part, on the data associated with the particular interactive response system, and where the signal is produced asynchronously with the progress of the outgoing communication.
